(19) United States
(12) Patent Application Publication
(10) Pub. No.: US 2004/0161159 A1
(43) Pub. Date: Aug. 19, 2004

(54) Device and method for enhancing vision in motor vehicles

(75) Inventors: Michael Holz, Senden (DE); Edgar Weidel, Senden (DE); Michael Weidel, Senden (DE)

Correspondence Address: DAVIDSON, DAVIDSON & KAPPEL, LLC, 485 SEVENTH AVENUE, 14TH FLOOR, NEW YORK, NY, 10018, US

(73) Assignee: DaimlerChrysler AG, Stuttgart (DE)

(21) Appl. No.: 10/762,673

(22) Filed: Jan. 22, 2004

(30) Foreign Application Priority Data
Jan. 24, 2003 (DE) DE 103 03 044.1

(51) Int. Cl. G06K 9/40; G06K 9/00

(52) U.S. Cl. 382/254; 382/162

(57) ABSTRACT

A vision-enhancing device for a motor vehicle has an image-recording device, an image-processing device and an image-display device, the image-processing device is configured to assign display color values for display by the image-display device to the input color values recorded by the image-recording device, certain display color values being provided for each input color value as a function of the environmental conditions.

Priority is claimed to German Patent Application No. DE 103 03 044.1, filed on Jan. 24, 2003, the entire disclosure of which is incorporated by reference herein.

### BACKGROUND

The present invention relates to devices and methods for enhancing vision in motor vehicles, as well as to vehicles equipped with said devices.

In general, vision enhancement devices for vehicles have an image-recording device such as a video or infrared camera, an image-processing device, and an image-display device such as a screen mounted in the vehicle in the driver's visual field. The camera records images from the surroundings and supplies them to the image-processing device, which then forwards the processed images to the screen for display.

DE 4007646 A1, which is incorporated by reference herein, describes such an infrared-based system. The approach presented there has a device in which the surroundings are illuminated by an infrared searchlight. The image of the surroundings is recorded using a CCD camera having a receiving optical system and is subsequently supplied to an image-display device for display.

An image of varying quality, depending on the surrounding situation, is thus presented to the driver; the weather situation, for example, may have a decidedly negative effect on the quality of the displayed image.

Another approach to imaging in vision-enhancement systems is presented in DE 100 16 184 A1, which is incorporated by reference herein. The system described therein is based on the fact that the quality of the image, after being recorded, is first evaluated for sharpness and contrast by a signal-processing logic. High-quality images are stored in an intermediary memory. These images are presented to the driver instead of the original images if the signal-processing logic recognizes images of a poorer quality. The problem here is that, if the recorded images are of low quality, images from the memory, which do not represent the instantaneous reality in the vehicle's surroundings and thus are usually obsolete, are used to a large extent. The risk of an accident is thus increased, rather than diminished, by the device described.

### SUMMARY OF THE INVENTION

An object of the present invention is to provide a vision-enhancement system for vehicles in which the presentation of the image data is improved.

The present invention provides a vision-enhancing device for motor vehicles, having an image-recording device, an image-processing device, and an image-display device, the image-processing device having means for assigning display color values for display by the image-display device to the input color values recorded by the image-recording device, wherein display color values determined as a function of the environmental conditions correspond to each input color value. The present invention also provides a method for enhancing vision in vehicles, input color values being detected using an image-recording device, and display color values being assigned to the input color values in an image-processing device, wherein the display color values are assigned to input color values as a function of environmental parameters.

A first advantageous embodiment of the present invention has an image-recording device such as, for example, a CCD camera, an image-processing device having means for storing and converting image data, and, for example, a screen as an image-display device. The image-recording device records certain input color values, determined by pixel or area, from the surroundings. This is accomplished by many commercially available color CCD cameras, for example, by spectrally separated recording of the intensities of the red, green, and blue components in the incident light in such a way that for the recorded input color value a triplet of digits of each detected intensity of the three primary colors is obtained. In contrast, infrared cameras typically record the intensity of the incident infrared radiation, so that in this case the input color value usually has a single measurement digit for the recorded intensity.

Subsequently, the image-processing device transforms this input color value into a display color value which is used as the basis for displaying the pixel and optionally its surroundings on the screen, i.e., a display color value, which is to be used as a basis for displaying the pixel and optionally its surroundings in an image-display device, is assigned to the recorded input color value.

This transformation takes place, however, according to the present invention, not statically as in the related art, but as a function of the environmental conditions or a parameter of the conditions. For example, different display color values are selected for an input color value as a function of the weather situation. In this way the driver is presented with an image that is easy to recognize, informative, and relevant.

The present invention thus takes into account the fact that the image data recorded by the camera of a vision-enhancement system has widely different characteristics as a function of the weather and time of the day, for example. Thus, for example, images taken by an infrared camera at night and with a dry roadway contain driver-relevant information mainly in the low-intensity range, while in the presence of fog this information is to be found mainly in the mid-intensity range.

The device according to the present invention thus allows recorded image data to be processed in such a way that the viewer is presented an image having a high informational content.

The device according to the present invention thus makes it possible to sharpen the weak contrasts in the recorded image occurring in the event of fog, for example, for display, while at night and in rainy weather the sharpness of contrasts is reduced and thus the risk of glare which typically occurs in this situation is minimized.

The display of information that is relevant to the driver is ensured in any weather condition and under any lighting conditions that may occur, which considerably enhances the safety and user-friendliness of the vision-enhancement system used.

### BRIEF DESCRIPTION OF THE DRAWING

The present invention is described in more detail below with reference to the drawing, in which:

FIG. 1 shows a schematic view of a vision-enhancing device for a motor vehicle according to the present invention.

### DETAILED DESCRIPTION

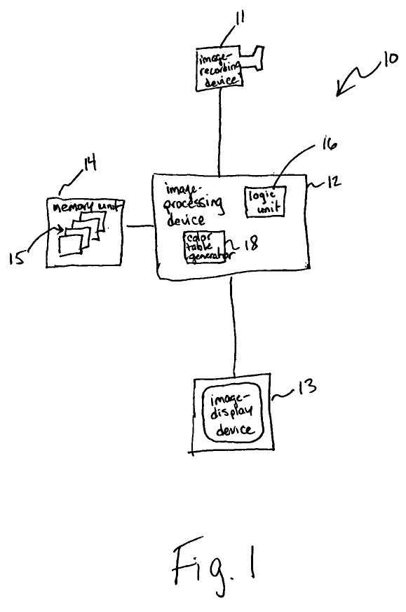

The vision-enhancing device 10, shown in FIG. 1, includes image-recording device 11 configured to record a plurality of input color values. Image-processing device 12 is configured to determine a plurality of display color values for display by image-display device 13, each display color value corresponding to a respective input color value and determined as a function of an environmental condition.

In a further advantageous embodiment of the present invention, a plurality of color tables 15 containing display color values corresponding to typical input color values are stored in a memory unit 14. Specifically, this means that certain display color values for different expected environmental scenarios are stored for possible input color values as schematically shown in the following table.

| | | | Display Color Value | | | | | |
|---|---|---|---|---|---|---|---|---|
| | | | Environmental Scenario: | | | Environmental Scenario: | | |
| Input Color Value | | | “rain” | | | “night” | | |
| R | G | B | R | G | B | R | G | B |
| 15 | 20 | 20 | 25 | 20 | 17 | 20 | 18 | 20 |
| 50 | 50 | 50 | 40 | 55 | 60 | 45 | 60 | 55 |
| 115 | 110 | 100 | 130 | 115 | 120 | 110 | 100 | 110 |

Thus, for example, for the input color value having (15, 20, 20) as the RGB value, (25, 20, 17) is used as the display color value for rain, (20, 18, 20) for night, and (30, 28, 23) for fog (not shown in the exemplary table above). The color table to be used in each case is adapted to and selectable according to a certain environmental scenario such as rain or night, for example.

The color tables for the particular scenarios may be determined in advance on the basis of experimental or statistical results.

It is possible to advantageously limit the memory required in the memory unit for the different color tables. For this purpose it is expedient not to store display color values for all occurring input color values but, for example, only for a certain proportion thereof. To determine a display color value for an input color value not stored in the color table, a logic unit 16 interpolates, for example, between the display color values of the two adjacent input color values stored in the color table.

Using the table shown above, this is explained for the environmental situation “rain,” for example. Let us assume that the input color value is (30, 30, 30), for example. Furthermore, we shall assume that the two closest input color values stored in the color table are (15, 20, 20) (corresponding display color value for rain (25, 20, 17)), and (50, 50, 50) (corresponding display color value for rain (40, 55, 60)). A linear interpolation for the individual components yields (31, 32, 31) as the respective display color value. In addition to linear interpolation, the logic unit 16 makes it possible to integrate additional, more complex formulas for interpolating to obtain display color values for the input color values not stored. The memory requirement for the color tables is thus significantly reduced and the complexity and cost of the memory unit are limited.

It is particularly advantageous to personalize the color tables, i.e., adapt them to the optical perception of the particular user. In particular, by using biometry-based access control and driving authorization systems, the assignment of appropriate color tables to the particular driver is simplified. Color tables adapted to the particular user are thus used for different users in the same environmental situation such as fog, for example. The image display adapted to the personal perception of the particular driver ensures greater acceptance of the device, combined with greater safety.

For adaptation to the current weather situation, it has been found particularly useful to select the appropriate color table, in particular automatically, using a value delivered by a sensor or information on the operating state of vehicle components, by a control device. In this connection, it is advantageous, for example, to use the output signal of the rain sensor as the decision-making criterion for the use of the appropriate table. As soon as rain is detected by the rain sensor, the corresponding sensor signal is supplied to the image-processing device 12 of the vision-enhancement system, which then selects the color table for rain to process the image. The screen image output to the driver is thus adapted to the current rain situation. The image-recording device 11 itself may also be used as a sensor in this case, the images recorded by it being used to determine the current environmental conditions and to select the color table to be used. Thus, for example, the weather situation may be determined just by evaluating the distribution of intensity values over the total number of pixels of a recorded infrared image (known as a histogram). Clusters at low- and high-intensity values indicate a high-contrast image of a scene at night and clear weather, while a cluster at mid-intensities indicates fog and therefore a low-contrast image. The color table to be used is selected in the image-processing device 12 after the environmental conditions have thus been classified.

It is also possible to use the operating states of vehicle components such as, for example, the windshield wiper or the fog lights as a selection criterion for the particular color table. Information already available via the on-board system regarding the particular operating states may be advantageously used in a simple manner.

In another advantageous variant of the present invention, the color tables to be used are selected via an operating action of a user. The user him/herself may determine, depending on the environmental situation, which display is appropriate for him/her. This functionality may be implemented via a rotary switch, for example, which permits simple selection of the desired display and thus the color table used. The selection of the display via a multifunction steering wheel, for example, and/or with the help of a menu-driven operating concept also permit the display to be conveniently adapted to the driver's personal preferences and/or to the current weather or lighting situation. The desired display characteristics may also be set via a voice input module. Selection of the image display by the user ensures that the displayed image meets the user's requirements and thus premature driver fatigue is effectively prevented when using the vision-enhancing device 10.

As an alternative to storing color tables containing fixed color values in the memory unit, it has been found useful to generate at least some of the color tables dynamically via a color table generator 18 using the input color values recorded by the image-recording device 11.

One possible exemplary method to accomplish this is explained in the following, assuming, for the sake of simplicity, the use of a black-and-white or infrared camera and a black-and-white or grayscale image-display device.

To compute the color tables to be used for the display, images taken in specific intervals, for example, every 10^{th} image, may be used.

First, the color table generator 18 in the image-processing device 12 evaluates the intensity distribution of the recorded image, i.e., the number of pixels having the corresponding intensity is determined for each of the intensity levels measurable by the image-recording device 11, i.e., a histogram is formed. To improve the quality of the output image, the maximum number of pixels to be taken into account per intensity level is limited, for example, to 100 or 1% of the total number of recorded pixels. With this measure, a grainy image output is largely avoided.

In the next step, the color table generator 18 assigns the recorded intensities to grayscale levels to be output.

First, quotient Q of the number of pixels taken into account to the number of displayable grayscale levels is formed. In the next step, the numbers of pixels taken into account from the histogram are added up consecutively starting with the lowest intensity level. As long as sum I thus determined is less than Q, the respective intensity values are mapped onto the lowest grayscale level. For values of I between Q and 2Q, the corresponding intensity values are mapped onto the second grayscale level, and so on. The contrast for the intensity ranges containing the maximum of the recorded pixels is thus automatically increased on the displayed page.

This dynamic type of assignment permits a significantly enhanced image, adjusted almost continuously to the current weather situation, to be achieved even under diverse conditions. Sudden changes in the display, which occur when switching between individual color tables that are different from each other, and user irritation due to the switch, are thus prevented.

Of course, a system that makes it possible to dynamically generate color tables for recording and reproducing color images is also implementable in a similar manner.

The above-described device is particularly well suited for use in infrared-based vehicle night-vision systems. In these systems moving image data having a high dynamic range, i.e., a plurality of levels of the recorded intensity values, is typically available. Since the human eye is only capable of distinguishing approximately 80 grayscale levels, the particular challenge here is to prepare the recorded intensity values for optimum perception by the driver. This creates the particular difficulty that few grayscale levels are available for display, while the intensity areas which contain information that is relevant to the driver shift as a function of weather and time of the day. Thus, for example, at night in dry weather low-intensity ranges predominate, while in fog the mid-range intensities predominate due to the scattered light.

The possible approaches disclosed in the present patent application take these circumstances into account by the fact that, according to the teaching of the present invention, the assignment of input color values to display color values is highly flexible and optionally even automatically adaptable to the particular weather conditions. The device according to the present invention thus significantly contributes to increasing traffic safety when using infrared night-vision systems.

The use of a grayscale or black-and-white image-display device offers a series of advantages in a further embodiment of the present invention.

Thus, the memory requirement for the color tables to be stored is substantially reduced, because only one grayscale value for the display must be stored for each input color value by the image-recording device 11.

The assignment of grayscale values to the input color values or the automatic generation of color tables is significantly simplified, so that a higher processing rate of the image data is achievable, which is particularly advantageous when moving images are displayed in real time, as required, for example, in a night-vision system.

Furthermore, the requirements for hardware used for image recording, processing, and display are reduced due to the use of grayscale value display.

One alternative is the use of a false color display for displaying the image data, where color values are assigned to display color values determined by the image-processing device 12, which are significantly different from the input color values. This permits the image to be displayed, optionally together with additional information, in a more user-friendly manner. In addition, the use of a false color image permits, for example, in connection with a head-up display, a safety measure to be implemented using psychological means: by selecting unrealistic colors for display, the driver is constantly reminded of the fact that he/she is viewing not an actual traffic scene, but an image generated electronically and modified by a plurality of image-processing measures.

The character of the system used as an assistance system, rather than a substitute for direct viewing through the windshield, and safety are thus enhanced.

In a particularly advantageous manner, the device according to the present invention is taken into consideration as early as at the time of the design of vehicles and integrated into new vehicles during manufacture. This permits measures to be taken in the vehicle's design to implement installation of the device without problems and ensure its proper operation.

In addition, the invention described in the present document refers to a method for enhancing the vision in vehicles, display color values being assigned to input color values recorded by an image-recording device as a function of an environmental condition. This method is adaptable to the needs of the particular user and to the current operating situation such as special regional conditions or seasonal conditions, for example, by suitable modification of the software components used, thus showing a high degree of flexibility.

What is claimed is:

1. A vision-enhancing device for a motor vehicle, comprising:
an image-recording device configured to record a plurality of input color values;
an image-display device; and
an image-processing device configured to determine a plurality of display color values for display by the image-display device, each display color value corresponding to a respective input color value and determined as a function of an environmental condition.

2. The device as recited in claim 2, further comprising a memory unit for storing a plurality of color tables, each color table assigning input color values to corresponding display color values and wherein the image-processing device selects at least one of the plurality of color tables as a function of the environmental condition.

3. The device as recited in claim 2, wherein the image-processing device includes a logic unit configured to determine display color values corresponding to input color values that are not stored in the plurality of color tables.

4. The device as recited in claim 2, wherein the at least one of the plurality of color tables is selectable taking into consideration a current user of the device.

5. The device as recited in claim 2, further comprising:
a sensor and a vehicle component having an operating state; and
a control device for selecting the one of the plurality of color tables using at least one of a value output of the sensor and information relating to the operating state of the vehicle component.

6. The device as recited in claim 5, wherein the control device is configured to select the at least one of the plurality of color tables using a property of an image data recorded by the image-recording device.

7. The device as recited in claim 2, further comprising an operating unit configured to select the at least one of the plurality of color tables from an operating action of a user.

8. The device as recited in claim 1, wherein the image-processing device includes a color table generator for generating the plurality of color tables using the input color values

9. The device as recited in claim 1, wherein the image-recording device is an infrared camera of a night-vision system.

10. The device as recited in claim 1, wherein the display color values are grayscale values.

11. The device as recited in claim 1, wherein the display color values are color values of a false color display.

12. A vehicle having the vision-enhancing device as recited in claim 1.

13. A method for enhancing vision in a vehicle, the method comprising:
detecting input color values using an image-recording device,
assigning display color values to the input color values using an image-processing device, wherein assigning of the display color values to input color values is performed as a function of an environmental parameter.
